(19) United States
(12) Patent Application Publication
(10) Pub. No.: US 2026/0236169 A1
(43) Pub. Date: Aug. 13, 2026

(54) CXL MEMORY SYSTEM AND OPERATING METHOD THEREOF

(71) Applicant: SK hynix Inc., Gyeonggi-do (KR)

(72) Inventors: Nam Hyun YUN, Gyeonggi-do (KR); Dong Sop LEE, Gyeonggi-do (KR)

(21) Appl. No.: 19/363,661

(22) Filed: Oct. 21, 2025

(30) Foreign Application Priority Data
Feb. 12, 2025 (KR) 10-2025-0017906
Apr. 25, 2025 (KR) 10-2025-0054196

(51) Int. Cl. G06F 3/06

(52) U.S. Cl. CPC G06F 3/061; G06F 3/0655; G06F 3/0679

(57) ABSTRACT

A CXL memory system may include a storage device configured to store data; a memory device configured to cache the data stored in the storage device; and a CXL controller configured to receive, from a host, a read request for target data through a CXL interface. The CXL controller is also configured to determine whether to transmit, to the host, a response message including information on a read latency required to read the target data.

### CROSS-REFERENCE TO RELATED APPLICATION

The present application claims priority under 35 U.S.C. §119(a) to Korean Patent Application Nos. 10-2025-0017906 filed on February 12, 2025 and 10-2025-0054196 filed on April 25, 2025, which are incorporated herein by reference in their entireties.

### BACKGROUND

### 1. Technical Field

Embodiments of the present disclosure relate to a Compute eXpress Link (CXL) memory system and an operating method thereof.

### 2. Related Art

Existing hosts use memory through a dual in-line memory module (DIMM), but the maximum capacity of the memory is limited due to the limited number of pins in a central processing unit (CPU) and a chipset.

In order to solve this limitation, a Compute eXpress Link (CXL) memory system using CXL technology may be used. The CXL technology is an open standard for accelerating the performance of a CPU device and memory, and is a standard for cache coherence and memory expansion. Through the CXL technology, a host may utilize the CXL memory system as buffer memory.

The CXL memory system supports CXL sub protocols such as CXL.mem sub protocol, and may provide additional memory capacity to the host by being connected to the host without a physical limitation in the number of pins.

### SUMMARY

Embodiments of the present disclosure are directed to providing a CXL memory system and an operating method thereof, capable of improving task processing performance of a host by transmitting, to the host, information on latency required to read data.

Objects of embodiments of the disclosure are not limited to those set forth herein, and other unmentioned objects would be apparent to one of ordinary skill in the art from the following description.

In an embodiment, a Compute eXpress Link (CXL) memory system may include: a storage device configured to store data; a memory device configured to cache the data stored in the storage device; and a CXL controller configured to receive, from a host, a read request for target data through a CXL interface, and determine whether to transmit, to the host, a response message including information on a read latency required to read the target data.

In an embodiment, a method of operating a Compute eXpress Link (CXL) memory system, including a storage device. a memory device, and a CXL controller, may include: receiving, by the CXL controller, a read request for target data from a host through a CXL interface; calculating, by the CXL controller, a read latency required to read the target data from the storage device or the memory device; and determining, by the CXL controller, based on the read latency, whether to transmit, to the host, a response message including information on the read latency.

In an embodiment, a memory system may include: a storage device configured to store data; a memory device configured to cache the data stored in the storage device; and a controller configured to communicate with a host through a preset interface and control the storage device and the memory device. The controller may be configured to receive, from the host, a read request for target data from the storage device or the memory device, and may determine whether to transmit, to the host, a response message including information on a read latency required to read the target data.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a schematic configuration diagram of a CXL memory system according to an embodiment of the present disclosure.

FIG. 2 is a diagram illustrating the schematic operation of the CXL memory system according to an embodiment of the present disclosure.

FIG. 3 is a diagram illustrating an example of an operation in which the CXL memory system according to an embodiment of the present disclosure determines whether to transmit a response message.

FIG. 4 is a diagram illustrating another example of the operation in which the CXL memory system according to an embodiment of the present disclosure determines whether to transmit a response message.

FIG. 5 and FIG. 6 are diagrams illustrating an example of an operation in which the CXL memory system according to an embodiment of the present disclosure processes a read request.

FIG. 7 and FIG. 8 are diagrams illustrating another example of the operation in which the CXL memory system according to an embodiment of the present disclosure processes a read request.

FIG. 9 is a flowchart illustrating a method of operating a CXL memory system according to an embodiment of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

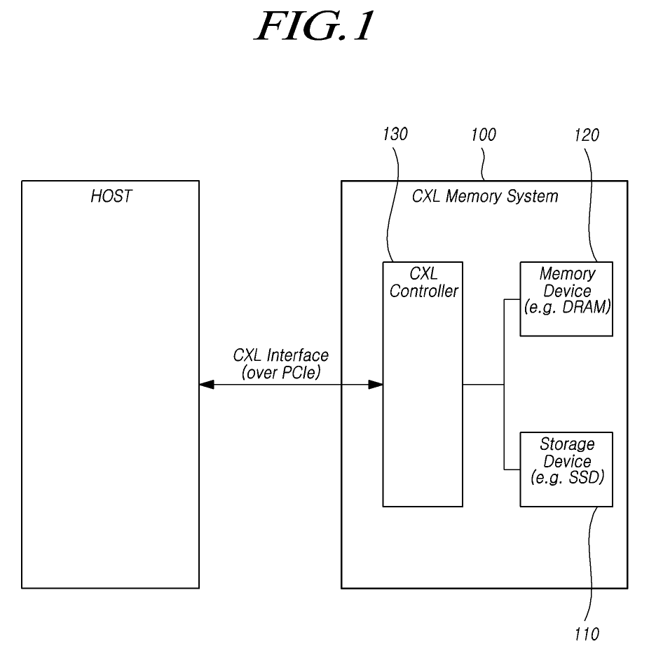

FIG. 1 is a schematic configuration diagram of a CXL memory system 100 according to an embodiment of the present disclosure.

Referring to FIG. 1, the CXL memory system 100 may include a storage device 110, a memory device 120, and a CXL controller 130.

The storage device 110 may store data. For example, the storage device 110 may be a device (e.g., a solid-state drive (SSD) that includes nonvolatile memory (e.g., NAND Flash, MRAM or PRAM) to store data. The storage device 110 may store a large amount of data and may operate at low speed (for example, relative to the memory device 120).

The memory device 120 may cache data stored in the storage device 110. The memory device 120 may have a smaller storage capacity than the storage device 110 and may operate at high speed (for example, relative to the storage device 110). Therefore, by caching data from the storage device 110 to the memory device 120, the CXL memory system 100 may process a read request from the outside more quickly.

When data cached in the memory device 120 is modified and becomes a dirty state (for example, the data cached in the memory device 120 is modified and differs from the data stored in the storage device 110), the CXL memory system 100 may flush the data cached in the memory device 120 to the storage device 110.

The memory device 120 may be implemented in various ways. For example, the memory device 120 may be volatile memory (e.g., DRAM (dynamic random-access memory) or SRAM (static random-access memory)).

The CXL controller 130 may control the storage device 110 and the memory device 120, and may communicate with a host HOST through a CXL interface. Through this, the host HOST may increase available memory capacity and bandwidth without adding separate memory channels.

The CXL interface may operate on the basis of PCIe (Peripheral Component Interconnect Express). In embodiments of the present disclosure, the CXL interface may operate on the basis of a CXL.mem sub protocol.

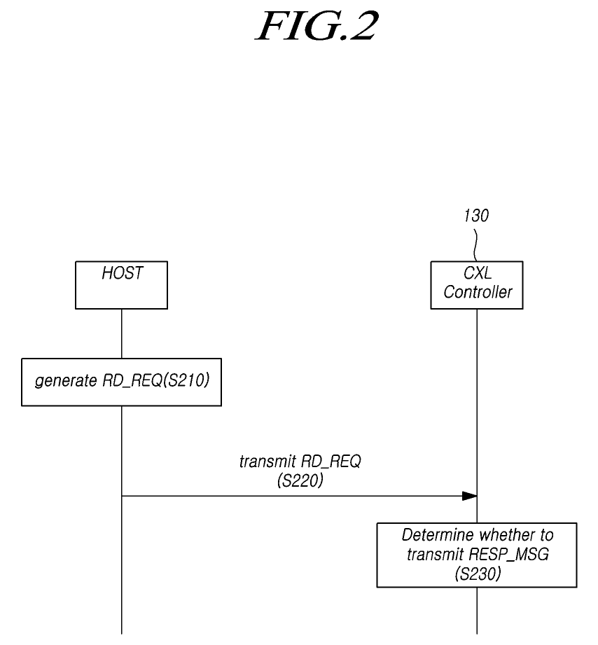

FIG. 2 is a diagram illustrating the schematic operation of the CXL memory system 100 according to an embodiment the present disclosure.

Referring to FIG. 2, the host HOST may generate a read request RD_REQ for target data (S210) which is stored in the CXL memory system 100 (e.g., the storage device 110 or the memory device 120).

The host HOST may transmit the read request RD_REQ to the CXL controller 130 of the CXL memory system 100 through the CXL interface (S220).

Upon receipt of the read request RD_REQ, the CXL controller 130 may determine whether to transmit, to the host HOST, a response message RESP_MSG to the read request RD_REQ (S230).

The response message RESP_MSG may include information on a read latency required to read the target data. For example, the read latency may indicate a time from a time point at which the CXL controller 130 receives the read request RD_REQ to a time point at which the CXL controller 130 transmits the target data to the host HOST in response to the read request RD_REQ.

At a time point at which the host HOST transmits the read request RD_REQ to the CXL memory system 100, the host HOST may not be capable of determining (for example, cannot be aware, is unaware of) how long it will take to read the target data. This is because the read latency may vary depending on whether the target data is cached in the memory device 120 (or in another location, such as the storage device 110). In other words, the host may not be aware of whether the target data is stored in the memory device 120 or the storage device 110.

The process by (or with) which the host HOST processes a task may vary depending on the size of the read latency. The task may be a job, a process, a thread, or the like that is processed by the CPU of the host HOST.

In an instance in which the read latency is large, it is advantageous for the host HOST to execute another task rather than continue to wait for the target data. On the other hand, in instances in which the read latency is small, it is advantageous for the host HOST to wait for the target data from the CXL memory system 100 to avoid an overhead due to task switching.

Therefore, in order to enable the host HOST to determine whether to wait for the target data or perform task switching to improve task processing performance, the CXL controller 130 may transmit, the host HOST, the response message RESP_MSG including the information on a read latency to.

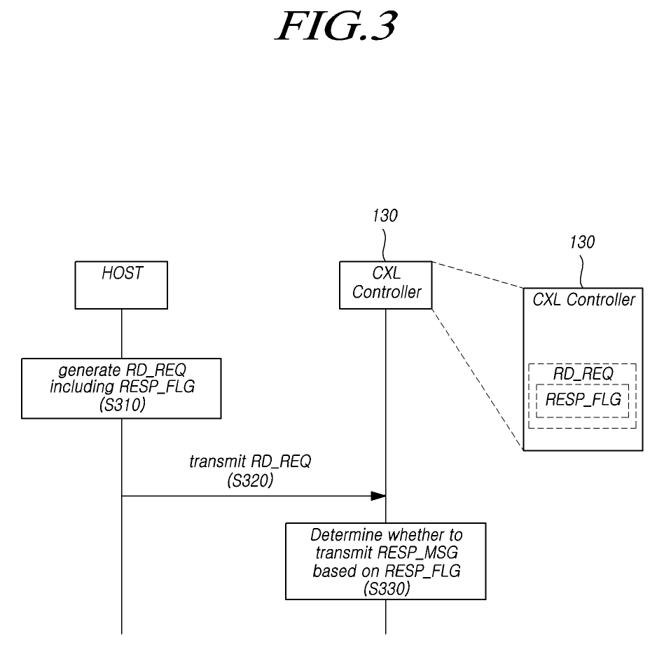

FIG. 3 is a diagram illustrating an example of an operation in which the CXL memory system 100 according to an embodiment of the present disclosure determines whether to transmit a response message RESP_MSG.

Referring to FIG. 3, the host HOST may generate a read request RD_REQ for target data (S310). The read request RD_REQ may include a response flag RESP_FLG.

The response flag RESP_FLG may indicate whether the transmission of the above-described response message RESP_MSG to the host HOST is enabled. For example, the response flag RESP_FLG as a 1-bit flag may have a first value (e.g., 1) or a second value (e.g., 0).

The host HOST may transmit the read request RD_REQ (including the response flag RESP_FLG) to the CXL controller 130 of the CXL memory system 100 through the CXL interface (S320).

Upon receipt of the read request RD_REQ, the CXL controller 130 may determine whether to transmit the response message RESP_MSG to the host HOST based on (on the basis of) the response flag RESP_FLG included in the read request RD_REQ (S330).

In instances in which the response flag RESP_FLG indicates that the transmission of the response message RESP_MSG to the host HOST is enabled, the CXL controller 130 may determine whether to transmit the response message RESP_MSG to the host HOST.

On the other hand, in instances in which the response flag RESP_FLG indicates that the transmission of the response message RESP_MSG to the host HOST is not enabled, the CXL controller 130 may not transmit the response message RESP_MSG to the host HOST.

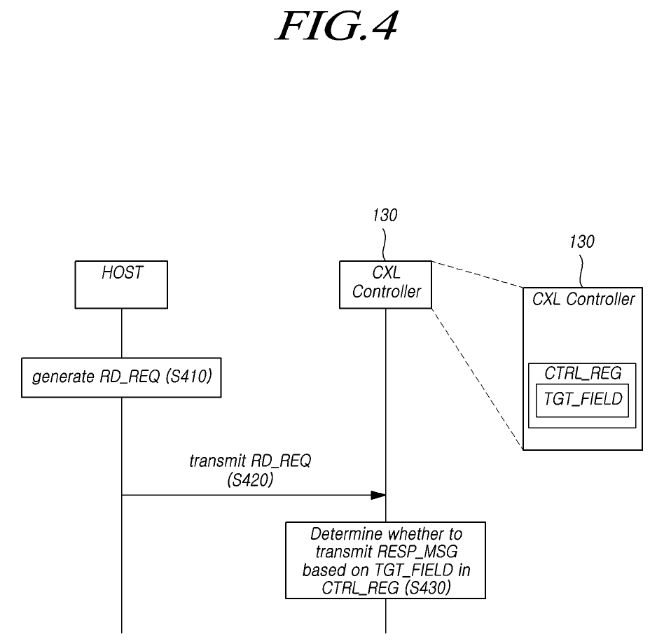

FIG. 4 is a diagram illustrating another example of an operation in which the CXL memory system 100 according to an embodiment of the present disclosure determines whether to transmit a response message RESP_MSG.

Referring to FIG. 4, the host HOST may generate a read request RD_REQ for target data (S410).

The host HOST may transmit the read request RD_REQ to the CXL controller 130 of the CXL memory system 100 through the CXL interface (S420).

Upon receipt of the read request RD_REQ, the CXL controller 130 may determine whether to transmit a response message RESP_MSG to the host HOST based on (i.e., on the basis of) a target field TGT_FIELD of a control register CTRL_REG included in the CXL controller 130 (S430).

The control register CTRL_REG may be implemented in various ways. For example, the control register CTRL_REG may be a CXL timeout and isolation control register that is defined in the CXL standard. The target field TGT_FIELD may be a specific bit (e.g., a fifth bit) of the control register CTRL_REG.

The CXL controller 130 may additionally store setting information on whether to support an operation of determining whether to transmit the response message RESP_MSG to the host HOST. For example, the setting information may be a specific bit (e.g., a seventh bit) of a CXL timeout and isolation capability register that is defined in the CXL standard.

When the setting information indicates that the operation of determining whether to transmit the response message RESP_MSG to the host HOST is supported, the CXL controller 130 may determine whether to transmit the response message RESP_MSG to the host HOST based on the target field TGT_FIELD of the control register CTRL_REG.

As described above, the CXL controller 130 may determine whether to transmit, to the host HOST, the response message RESP_MSG including information on a read latency required to read the target data.

To this end, the CXL controller 130 may calculate a read latency (required to read the target data). The CXL controller 130 may calculate the read latency in various ways.

For example, the CXL controller 130 may calculate a read latency on the basis of at least one of whether the target data is cached in the memory device 120 and a depth of a read queue in which read commands for the storage device 110 are queued.

In instances in which the target data is cached in the memory device 120, because the memory device 120 operates at a faster speed than the storage device 110, the CXL controller 130 may determine that the read latency is smaller than when the target data is not cached in the memory device 120.

Meanwhile, as the depth of the read queue increases, a time for which a command (that requests to read the target data from the storage device 110) waits in the read queue increases, and thus, the CXL controller 130 may determine that the read latency is large.

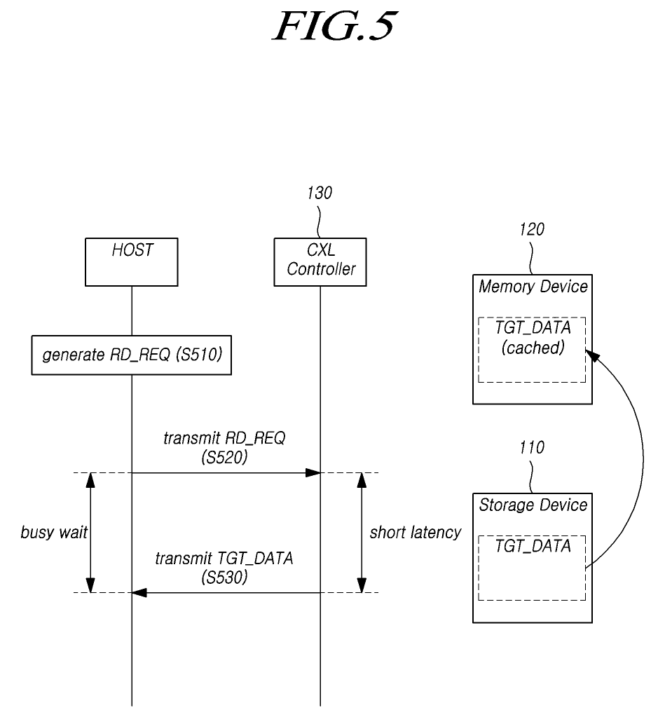

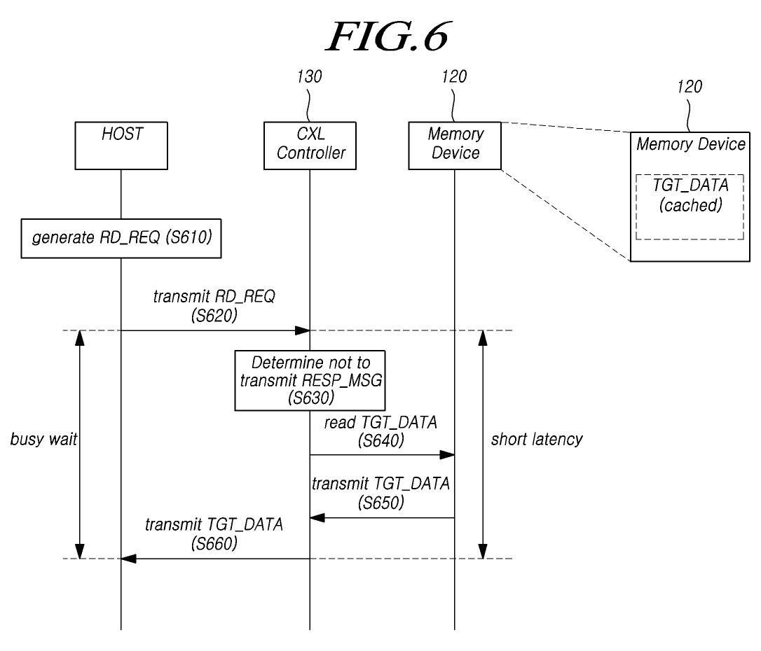

FIGS. 5 and 6 are diagrams illustrating an example of an operation in which the CXL memory system 100 according to the present disclosure processes a read request RD_REQ.

Referring to FIG. 5, the host HOST may generate a read request RD_REQ for target data TGT_DATA (S510).

The host HOST may transmit the read request RD_REQ to the CXL controller 130 of the CXL memory system 100 through the CXL interface (S520).

Upon receipt of the read request RD_REQ, the CXL controller 130 may transmit the target data TGT_DATA to the host HOST (S530). Because the target data TGT_DATA is cached in the memory device 120 as shown in FIG. 5, a read latency that is required from a time point at which the CXL controller 130 receives the read request RD_REQ to a time point at which the CXL controller 130 reads the target data TGT_DATA is small.

Therefore, after transmitting the read request RD_REQ to the CXL controller 130, the host HOST may wait for the target data TGT_DATA. This is because a loss incurred by an operation for the host HOST to wait for the target data TGT_DATA is smaller than an overhead incurred when the host HOST performs task switching.

Hereunder, an example of the operation described above with reference to FIG. 5 will be described in more detail with reference to FIG. 6.

Referring to FIG. 6, the host HOST may generate a read request RD_REQ for target data TGT_DATA (S610).

The host HOST may transmit the read request RD_REQ to the CXL controller 130 of the CXL memory system 100 through the CXL interface (S620).

In instances in which the target data TGT_DATA is cached in the memory device 120, the CXL controller 130 may determine not to transmit a response message RESP_MSG to the host HOST (S630). This is because a read latency required for the CXL controller 130 to transmit the target data TGT_DATA in response to the read request RD_REQ is small and the target data TGT_DATA may be immediately transmitted to the host HOST without the need to separately transmit the response message RESP_MSG.

The CXL controller 130 may read the target data TGT_DATA from the memory device 120 in response to the read request RD_REQ (S640). The memory device 120 may transmit the target data TGT_DATA to the CXL controller 130 in response to a request from the CXL controller 130 (S650).

The CXL controller 130 may transmit the target data TGT_DATA to the host HOST (S660). As described above with reference to FIG. 5, the host HOST waits for the target data TGT_DATA after transmitting the read request RD_REQ to the CXL controller 130. The host HOST may immediately receive the target data TGT_DATA from the CXL controller 130.

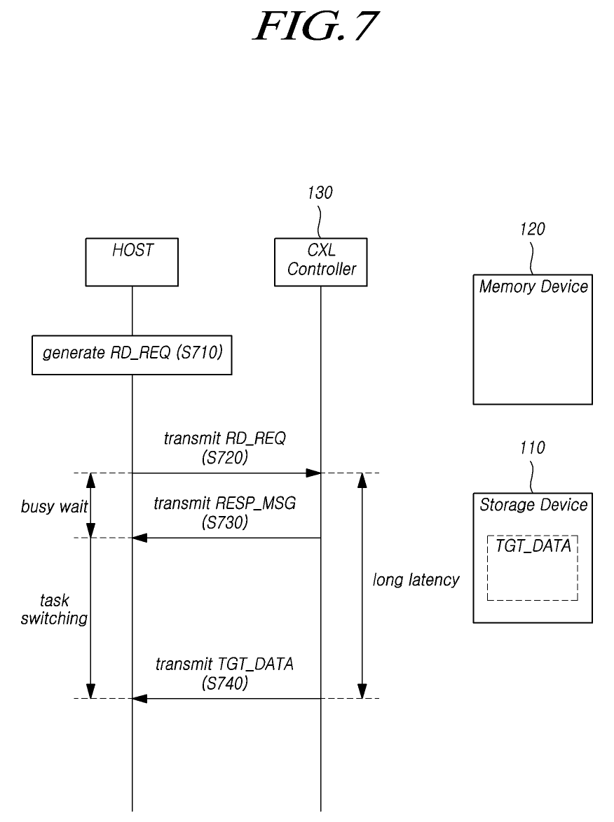

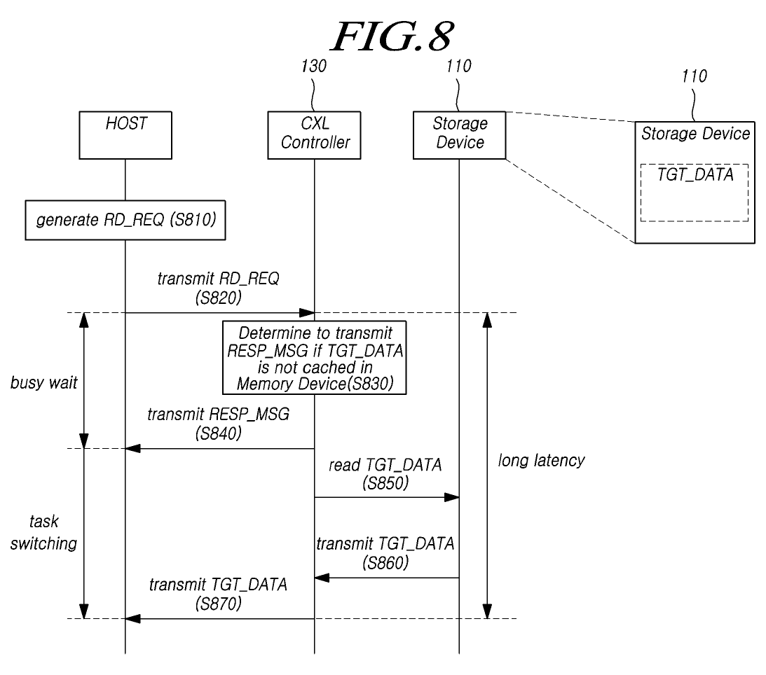

FIGS. 7 and 8 are diagrams illustrating another example of the operation in which the CXL memory system 100 according to embodiments of the present disclosure processes a read request RD_REQ.

Referring to FIG. 7, the host HOST may generate a read request RD_REQ for target data TGT_DATA (S710).

The host HOST may transmit the read request RD_REQ to the CXL controller 130 of the CXL memory system 100 through the CXL interface (S720).

Before transmitting the target data TGT_DATA to the host HOST, the CXL controller 130 may transmit, to the host HOST, a response message RESP_MSG including information on a read latency (S730).

The response message RESP_MSG may be an NDR (No Data Response) message that does not include the target data TGT_DATA. The response message RESP_MSG may include an operator code indicating that the response message RESP_MSG includes information on a read latency.

Upon receipt of the response message RESP_MSG, the host HOST may perform task switching to perform another task instead of continuing to wait for the target data TGT_DATA. The HOST may stop a currently executed task and perform another task.

Because the target data TGT_DATA is not cached in the memory device 120 as shown in FIG. 7, a read latency required for the CXL controller 130 to read the target data TGT_DATA from the storage device 110 is large. In this case, performance degradation that occurs while the host HOST waits for the target data TGT_DATA is greater than an overhead due to task switching.

Therefore, the CXL controller 130 may first transmit the response message RESP_MSG to the host HOST to inform the host HOST that the host HOST does not need to continue to wait for the target data TGT_DATA.

Upon receipt of the response message RESP_MSG, because a latency required to read the target data TGT_DATA is large, the host HOST may perform another task instead without continuing to wait for the target data TGT_DATA, to improve task processing performance.

Thereafter, the CXL controller 130 may read the target data TGT_DATA from the storage device 110 and transmit the target data TGT_DATA to the host HOST (S740). In order to process the received target data TGT_DATA, the host HOST may perform task switching again to perform the original task (i.e., the task that generated the read request RD_REQ for the target data TGT_DATA).

Hereunder, an example of the operation described above with reference to FIG. 7 will be described in more detail with reference to FIG. 8.

Referring to FIG. 8, the host HOST may generate a read request RD_REQ for target data TGT_DATA (S810).

The host HOST may transmit the read request RD_REQ to the CXL controller 130 of the CXL memory system 100 through the CXL interface (S820).

In instances in which the target data TGT_DATA is not cached in the memory device 120, the CXL controller 130 may determine to transmit a response message RESP_MSG to the host HOST (S830).

Accordingly, the CXL controller 130 may transmit the response message RESP_MSG to the host HOST in response to the read request RD_REQ (S840). Similarly to the process described herein above with respect to FIG. 7, after receiving the response message RESP_MSG, the host HOST may perform task switching to perform another task instead of continuing to wait for the target data TGT_DATA. The HOST may stop a currently executed task and perform another task.

The CXL controller 130 may read the target data TGT_DATA from the storage device 110 (S850). The storage device 110 may transmit the target data TGT_DATA to the CXL controller 130 in response to a request from the CXL controller 130 (S860).

The CXL controller 130 may transmit the target data TGT_DATA to the host HOST (S870). Similarly to the process described herein above with respect to FIG. 7, in order to process the received target data TGT_DATA, the host HOST may perform task switching again to perform the original task (i.e., the task that generated the read request RD_REQ for the target data TGT_DATA).

Information on a read latency included in the response message RESP_MSG may be configured in various ways.

For example, information on a read latency may indicate whether the read latency is greater than or equal to a preset threshold latency. When a read latency is greater than or equal to the threshold latency, the information on a read latency may be set to a first value (e.g., 1). When a read latency is less than the threshold latency, the information on a read latency may be set to a second value (e.g., 0).

The CXL controller 130 may store therein the value of the threshold latency. For example, the CXL controller 130 may store the value of the threshold latency in M (M is a natural number or 2 or more) number of bits included in the aforementioned CXL timeout and isolation control register.

For another example, information on a read latency may indicate the size of the read latency. The information on a read latency may be expressed by N (N is a natural number of 2 or more) number of bits.

For another example, a read latency may be one of K (K is a natural number of 2 or more) number of candidate values, and each candidate value may correspond to a specific size range of the read latency.

In the above, the operation of the CXL memory system 100 has been described. However, the above-described operation is not limited to the CXL memory system 100, and may also be applied to a general memory system that communicates with the host HOST through an interface other than the CXL interface.

For example, a memory system may include the storage device 110 and the memory device 120 described above and a separate controller. The controller may receive a read request for target data from the host HOST, and may determine whether to transmit a response message including information on a read latency required to read the target data to the host HOST, according to the method described above with reference to FIGS. 1 to 8.

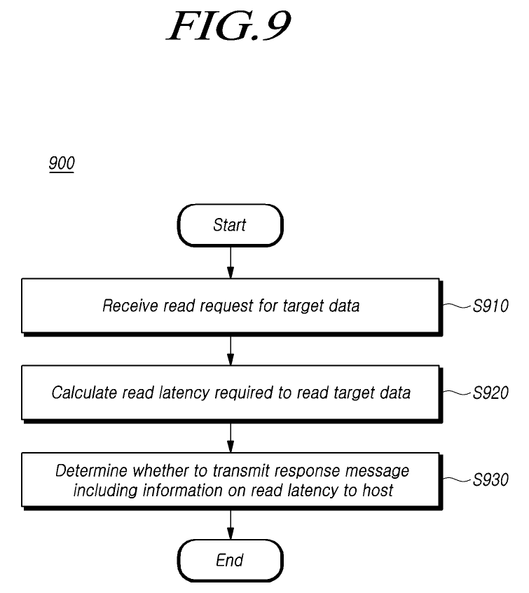

FIG. 9 is a flowchart illustrating a method 900 of operating a CXL memory system 100 according to the present disclosure.

Referring to FIG. 9, the method 900 of operating the CXL memory system 100 may include an operation S910 of receiving a read request RD_REQ for target data TGT_DATA from a host HOST through a CXL interface.

The method 900 of operating the CXL memory system 100 may include an operation S920 of calculating a read latency required to read the target data TGT_DATA.

For example, the operation S920 may calculate a read latency on the basis of at least one of whether the target data TGT_DATA is cached in the memory device 120 and the depth of a read queue in which read commands for the storage device 110 are queued.

The method 900 of operating the CXL memory system 100 may include an operation S930 of determining whether to transmit a response message RESP_MSG including information on a read latency to the host HOST.

For example, the read request RD_REQ may include a response flag RESP_FLG that indicates whether the transmission of the response message RESP_MSG to the host HOST is enabled. In instances in which the response flag RESP_FLG indicates that the transmission of the response message RESP_MSG to the host HOST is enabled, the operation S930 may determine whether to transmit the response message RESP_MSG to the host HOST. On the other hand, in instances in which the response flag RESP_FLG indicates that the transmission of the response message RESP_MSG to the host HOST is not enabled, the operation S930 may not transmit the response message RESP_MSG to the host HOST.

For example, the CXL memory system 100 may include a control register CTRL_REG. The operation S930 may determine whether to transmit the response message RESP_MSG to the host HOST, on the basis of a target field TGT_FIELD of the control register CTRL_REG.

For example, when the target data TGT_DATA is cached in the memory device 120, the operation S930 may determine not to transmit the response message RESP_MSG to the host HOST.

According to another embodiment, in instances in which the target data TGT_DATA is not cached in the memory device 120, the operation S930 may determine to transmit the response message RESP_MSG to the host HOST before transmitting the target data to the host HOST.

The information on a read latency included in the response message RESP_MSG may indicate whether the read latency is greater than or equal to a preset threshold latency. The information on a read latency may indicate the size of the read latency.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A Compute eXpress Link (CXL) memory system comprising:
a storage device configured to store data;
a memory device configured to cache the data stored in the storage device; and
a CXL controller configured to
receive, from a host, a read request for target data through a CXL interface, and
determine whether to transmit, to the host, a response message including information on a read latency required to read the target data.

2. The CXL memory system according to claim 1, wherein
the read request includes a response flag that indicates whether transmission of the response message to the host is enabled, and
when the response flag indicates that transmission of the response message to the host is enabled, the CXL controller is configured to determine transmission of the response message to the host, and
when the response flag indicates that transmission of the response message to the host is not enabled, the CXL controller is configured to not transmit the response message to the host.

3. The CXL memory system according to claim 1, wherein
the CXL controller includes a control register, and
the CXL controller is configured to determine whether to transmit the response message to the host based on a target field of the control register.

4. The CXL memory system according to claim 1, wherein the CXL controller is configured to calculate the read latency based on at least one of whether the target data is cached in the memory device and a depth of a read queue in which read commands for the storage device are queued.

5. The CXL memory system according to claim 1, wherein the CXL controller is configured to determine not to transmit the response message to the host when the target data is cached in the memory device.

6. The CXL memory system according to claim 1, wherein the CXL controller is configured to determine to transmit the response message to the host before transmitting the target data to the host in response to a determination that the target data is not cached in the memory device.

7. The CXL memory system according to claim 6, wherein the information on the read latency indicates that the read latency is greater than or equal to a preset threshold latency.

8. The CXL memory system according to claim 6, wherein the information on the read latency indicates a size of the read latency.

9. A method of operating a Compute eXpress Link (CXL) memory system including a storage device. a memory device, and a CXL controller, the method comprising:
receiving, by the CXL controller, a read request for target data from a host through a CXL interface;
calculating, by the CXL controller, a read latency required to read the target data from the storage device or the memory device; and
determining, by the CXL controller, based on the read latency, whether to transmit, to the host, a response message including information on the read latency.

10. The method according to claim 9, wherein
the read request includes a response flag that indicates whether transmission of the response message to the host is enabled, and
the determining whether to transmit a response message to the host includes determining transmission of the response message to the host in response to a determination that the response flag indicates that transmission of the response message to the host is enabled, and
the determining whether to transmit a response message to the host includes determining no transmission of the response message to the host in response to a determination that the response flag indicates that transmission of the response message to the host is not enabled.

11. The method according to claim 9, wherein
the CXL memory system includes a control register, and
the determining whether to transmit a response message to the host includes determining whether to transmit the response message to the host based on a target field of the control register.

12. The method according to claim 9, wherein the calculating a read latency includes calculating the read latency based on at least one of whether the target data is cached in the memory device and a depth of a read queue in which read commands for the storage device are queued.

13. The method according to claim 9, wherein, when the target data is cached in the memory device, the determining whether to transmit a response message to the host includes determining no transmission of the response message to the host.

14. The method according to claim 9, wherein, when the target data is not cached in the memory device, the determining whether to transmit a response message to the host includes determining transmission of the response message to the host before transmitting the target data to the host.

15. The method according to claim 14, wherein the information on the read latency indicates whether the read latency is greater than or equal to a preset threshold latency.

16. The method according to claim 14, wherein the information on the read latency indicates a size of the read latency.

17. A memory system comprising:
a storage device configured to store data;
a memory device configured to cache the data stored in the storage device; and
a controller configured to communicate with a host through a preset interface and control the storage device and the memory device,
wherein the controller is configured to receive, from the host, a read request for target data from the storage device or the memory device, and determine whether to transmit, to the host, a response message including information on a read latency required to read the target data.
